(19) United States
(12) Patent Application Publication
(10) Pub. No.: US 2026/0230730 A1
(43) Pub. Date: Aug. 6, 2026

(54) PIXEL ARRANGEMENT, IMAGING DEVICE AND METHOD FOR OPERATING A PIXEL ARRANGEMENT

(71) Applicant: ams Sensors Belgium BV, Antwerpen (BE)

(72) Inventor: Koen RUYTHOOREN, Hever (BE)

(21) Appl. No.: 19/152,951

(22) PCT Filed: Mar. 5, 2024
(86) PCT No.: PCT/EP2024/055708

§ 371 Date: Aug. 1, 2025

(30) Foreign Application Priority Data
Mar. 16, 2023 (DE) 10 2023 106 613.7

(51) Int. Cl. H04N 25/78; H04N 25/531; H04N 25/532; H04N 25/771

(52) U.S. Cl. CPC H04N 25/78; H04N 25/531; H04N 25/532; H04N 25/771

(57) ABSTRACT

A pixel arrangement (1) comprises a conversion stage (10) configured to convert electromagnetic radiation into electrical signals, a sample-and-hold stage (20) configured to store electrical signals from the conversion stage (10), a readout stage (30) configured to read electrical signals stored in the sample-and-hold stage (20), a first amplifier (40) electrically connected at its input (41) to the conversion stage (10) and at its output (42) to the sample-and-hold stage (20), a second amplifier (50) electrically connected at its input (52) to the sample-and-hold stage (20) and at its output (53) to the readout stage (30), wherein the second amplifier (50) is switchably electrically coupled to a supply terminal (59), and a switchable electrical interconnection (60) between the output (42) of the first amplifier (40) and the output (53) of the second amplifier (50), the electrical interconnection (60) being electrically arranged in parallel with the sample-and-hold stage (20).

The present invention relates to a pixel arrangement, an imaging device and a method for operating a pixel arrangement.

### BACKGROUND OF THE INVENTION

A pixel arrangement can be optimized for global shutter (GS) or rolling shutter (RS) mode. In rolling shutter mode the pixels of a pixel matrix are sequentially exposed and read out row-by-row. The rolling shutter mode enables high resolution of an imaging device, but could come with drawbacks like long illumination times and dynamic or color artifacts. In global shutter mode all pixels are exposed during the same time period. At the end of integration, the signals are transferred simultaneously. The signals are stored on in-pixel sample capacitors and subsequently read out.

Charge signals generated at a conversion stage of the pixel by accumulating charge carriers during the exposure to electromagnetic radiation may be transformed into voltage domain. Thus, a voltage domain global shutter (VGS) pixel may be formed. A VGS pixel may have many advantages like fast readout, low parasitic light sensitivity (PLS) or pipelining integration and readout. However, noise may be a disadvantage of a VGS pixel. The noise is limited by the size of the in-pixel sample capacitors. Some applications may benefit from a lower noise readout mode, which does not necessarily need the global shutter function. Reading out in rolling shutter mode would significantly reduce the pixel noise.

An object to be achieved is to provide a pixel arrangement with fast and low noise readout and a method for operating such pixel arrangement. A further object is to provide an imaging device comprising the pixel arrangement.

These objects are achieved with the subject-matter of the independent claims. Further developments and embodiments are described in dependent claims.

### SUMMARY OF THE INVENTION

Here and in the following, the terms “pixel” or “pixel arrangement” may refer to a light receiving element, which might be arranged in a two-dimensional array, also called matrix, with other pixels. This means that the pixel arrangement may be comprised by a pixel array. Pixels in the array are arranged in rows and columns. The terms “row” and “column” can be used interchangeably, since they depend only on the orientation of the pixel array. The pixel might also include circuitry for controlling signals to and from the pixel. Thus, the pixel may form a so-called active pixel. The pixel may receive light in an arbitrary wavelength range. The term “light” may refer to electromagnetic radiation in general, including infrared (IR) radiation, ultraviolet (UV) radiation and visible (VIS) light, for example. Further, here and in the following, the terms “electrically connected” and “electrically coupled” may refer to a direct or indirect connection between two electrical components. A direct connection of two components means that no further components are arranged in between. An indirect connection of two components means that further components are arranged in between. Preferably, “electrically connected” means a direct connection, while “electrically coupled” means an indirect connection.

In an embodiment, the pixel arrangement comprises a conversion stage configured to convert electromagnetic radiation into electrical signals.

In an embodiment, the conversion stage comprises a photodetector. The photodetector may be configured to accumulate charge carriers by converting electromagnetic radiation. Thus, a charge signal is generated. For example, the photodetector comprises a photodiode, in particular a pinned photodiode. The photodiode may be arranged in a substrate, in particular a semiconductor substrate. Photodetectors, in particular photodiodes can detect electromagnetic radiation.

In an embodiment, the conversion stage further comprises a transfer switch and a circuit node. The transfer switch may be implemented as transfer transistor. The circuit node may be implemented as diffusion node, in particular floating diffusion node. The circuit node may be called FD-node. The circuit node forms an output of the conversion stage. The circuit node comprises a capacitance. The capacitance forms a storage element of the pixel arrangement. The circuit node may be formed by a doped well in the semiconductor substrate or by a storage capacitor. By means of the circuit node the charge signal may be transformed into a voltage signal. Thus, the electrical signals generated at the conversion stage may be charge signals and/or voltage signals. The transfer switch is electrically connected between the photodetector and the circuit node. If the transfer switch is implemented as transfer transistor it comprises a first terminal that is electrically connected to a terminal of the photodetector, in particular to a cathode terminal of the photodiode. A second terminal of the transfer transistor is electrically connected to the circuit node. A gate terminal of the transfer transistor is configured to receive a transfer signal. By closing the transfer switch, i.e. by applying the transfer signal, charge carriers may diffuse from the photodetector to the circuit node.

In an embodiment, the conversion stage further comprises a reset switch. The reset switch is electrically connected between the circuit node and a supply terminal. The supply terminal may provide a pixel supply voltage, in particular a positive pixel supply voltage VDD. The reset switch may be implemented as reset transistor. A first terminal of the reset transistor is electrically connected to the circuit node. A second terminal of the reset transistor is electrically connected to the supply terminal. A gate terminal of the reset transistor is configured to receive a reset signal. By closing the reset switch, i.e. by applying the reset signal, the circuit node is reset, which means that redundant charge carriers are removed from the circuit node.

In an embodiment, the pixel arrangement further comprises a sample-and-hold stage configured to store electrical signals from the conversion stage. The sample-and-hold stage may be called S/H stage.

In an embodiment, the S/H stage comprises a first capacitor configured to store a voltage signal generated at the conversion stage. For example, the first capacitor is implemented as metal-oxide-semiconductor (MOS) capacitors. Alternatively, the capacitors may be formed as metal-insulator-metal (MIM) capacitors. Further, the capacitors may be implemented as metal fringe capacitors or as so-called poly-N capacitors. Other capacitor technologies are possible as well. The first capacitor can be a switchable first capacitor. That the first capacitor is switchable can mean that a first terminal of the first capacitor is electrically connected to a switch. For example, a first terminal of the first capacitor is electrically connected to a first switch, which may be implemented as transistor. A second terminal of the first capacitor may be electrically connected to a reference potential terminal. The first capacitor is electrically coupled via the first switch to an input of the S/H stage. The input of the S/H stage is electrically coupled to the output of the conversion stage, as explained below. The voltage signal may be a video signal. The video signal may refer to a signal level corresponding to a pixel of an image to be captured. The video signal thus corresponds to the accumulated charges at the photodetector during exposure. Thus, the video signal is different from a reset level or a noise level.

In an embodiment, the S/H stage further comprises a second capacitor configured to store a further voltage signal generated at the conversion stage. The second capacitor may be implemented according to the same capacitor technologies as mentioned above. The second capacitor can be a switchable second capacitor. That the second capacitor is switchable can mean that a first terminal of the second capacitor is electrically connected to a switch. For example, a first terminal of the second capacitor is electrically connected to a second switch, which may be implemented as transistor. A second terminal of the second capacitor may be electrically connected to a further reference potential terminal. The reference potential Vref and the further reference potential Vref′ at the respective terminals may be equal or may be different. For example, the reference potential is ground (GND).

The second capacitor can be electrically coupled via the second switch to the input of the S/H stage. Further switches may be interposed between the second switch and the input of the S/H stage. For example, the second capacitor is electrically coupled via the second switch and the first switch to the input of the S/H stage. The further voltage level may be a reset level of the pixel arrangement. The reset level is the potential level of the circuit node after resetting it. The reset level provides information about fixed pattern noise (FPN) of the pixel array. The first capacitor and the second capacitor may be selectively electrically connected to the input and the output of the S/H stage.

In an embodiment, the first capacitor and the second capacitor are electrically arranged cascaded. This can mean that the second capacitor is electrically connected to the input of the S/H stage via a terminal of the first capacitor. For example, the second capacitor is electrically connected to the input of the S/H stage via the first and the second switch. In other words, only if both switches are closed, the second capacitor is electrically connected to the input of the S/H stage. Thus, an electrical signal from the conversion stage is distributed between the first and the second capacitor. The first terminal of the second capacitor can form the output of the S/H stage. Advantageously, fewer components are required than in the case of a parallel arrangement of the capacitors.

In an embodiment, the first capacitor and the second capacitor are electrically arranged in parallel. In that case, both capacitors can be electrically connected to the input of the S/H stage independently. For example, both first and second switch are electrically connected to the input of the S/H stage. In other words, the first switch is arranged between the first terminal of the first capacitor and the input of the S/H stage, and the second switch is arranged between the first terminal of the second capacitor and the input of the S/H stage. Both first terminal of the second capacitor and first terminal of the first capacitor form respective outputs of the S/H stage once the respective switches are closed. Advantageously, the first capacitor and the second capacitor can be controlled independently by the first and the second switch.

In an embodiment, the S/H stage comprises exactly one capacitor. In an embodiment, the S/H stage comprises exactly two capacitors. The capacitors form in-pixel storage capacitors. It is also possible, that the S/H stage comprises more than one capacitor or more than two capacitors. Each capacitor may be switchable, i.e. connected to a switch. Thus, each capacitor may be coupled to the input of the S/H stage and to the output of the S/H stage, respectively.

In an embodiment, the pixel arrangement comprises a readout stage configured to read electrical signals stored in the Sample-and-hold stage.

In an embodiment, the readout stage comprises a select switch and at least a portion of a column bus. The column bus may be common for all pixel of the respective column of the pixel array. The select switch may be implemented as select transistor. A first terminal of the select transistor is electrically connected to an input of the readout stage. A second terminal of the select transistor is electrically connected to the column bus. A gate terminal of the select transistor is configured to receive a select signal. By closing the select switch, i.e. by applying the select signal, the electrical signals generated at the conversion stage and/or stored in the sample-and-hold stage are forwarded to the column bus for further processing. For example, the column bus leads to a readout circuit. The readout circuit may be arranged in the semiconductor substrate next to the pixel arrangement or it may be arranged in a separate semiconductor substrate. For example, the readout circuit comprises an analog-to-digital converter (ADC).

In an embodiment, the pixel arrangement further comprises a first amplifier electrically connected at its input to the conversion stage and at its output to the sample-and-hold stage.

Thus, the first amplifier couples the conversion stage to the S/H stage. The first amplifier may be implemented as first source follower, also called common-drain amplifier. The input of the first amplifier may be formed by a gate terminal of the first source follower. The gate terminal of the first source follower may be electrically connected to the circuit node of the conversion stage. The output of the first amplifier may be formed by a source terminal of the first source follower. The source terminal may be electrically connected to the input of the S/H stage and thus to the switchable capacitors. A drain terminal of the first source follower may electrically connected to a further supply terminal, for example VDD. The first amplifier is configured to provide an electrical signal based on the accumulated charge carriers from the photodetector. The first amplifier may be used as voltage buffer and configured to buffer the signal, thus to decouple the circuit node from the S/H stage. The amplifier may further be configured to amplify the voltage signal and the further voltage signal. This can mean that altered/amplified versions of said voltage signals are stored on the capacitors. Thus, the amplifier may be configured to amplify the light-induced video signal and the reset level.

In an embodiment, the pixel arrangement further comprises a second amplifier electrically connected at its input to the sample-and-hold stage and at its output to the readout stage.

Thus, the second amplifier couples the S/H stage to the readout stage. The second amplifier may be implemented as second source follower. The input of the second amplifier may be formed by a gate terminal of the second source follower. The gate terminal of the second source follower may be electrically connected to the output of the S/H stage, and thus to the first capacitor and/or the second capacitor. The output of the second amplifier may be formed by a source terminal of the second source follower. The source terminal may be electrically connected to the input of the readout stage and thus to the select switch. A drain terminal of the second source follower may electrically connected to the supply terminal, for example VDD. The second amplifier is configured to provide an electrical signal based on the electrical signals stored in the S/H stage. The second amplifier may be used as voltage buffer and configured to buffer the signal, thus to decouple the S/H stage from the readout stage. The second amplifier may further be configured to amplify the stored voltage signal and the further voltage signal, e.g. the video signal and the reset level.

In an embodiment, the second amplifier is switchably electrically coupled to the supply terminal.

This can mean that the drain terminal of the second source follower is switchably electrically coupled to the supply terminal. That the second amplifier is switchably electrically coupled to the supply terminal can mean that a supply switch is electrically connected between the second amplifier and the supply terminal, such that the second amplifier is switchably electrically coupled to the supply terminal. In particular, the supply switch may be implemented as supply transistor. For example, a first terminal of the supply transistor is electrically connected to the second amplifier, in particular to the drain terminal of the second source follower. A second terminal of the supply transistor is electrically connected to the supply terminal. A gate terminal of the supply transistor is configured to receive a supply signal. By closing the supply switch, i.e. by applying the supply signal, the second amplifier can be turned on. By opening the supply switch, the second amplifier can be turned off.

It is noted that that the pixel arrangement may be part of a pixel array comprising a plurality of pixel arrangements. The supply switch can be the same for all pixel arrangements within an array of pixels. This means that it can be a global supply switch. It is also possible for the supply switch to be common for pixel arrangements within one row/column of a pixel array. In other words, the supply switch may be common for at least one group of pixel arrangements. Thus, fewer switches/transistors are required and the pixel arrangement can be implemented without adding extra transistors in each pixel. In an embodiment, however, a separate supply switch is provided for each pixel arrangement. In that embodiment, advantageously, each pixel can be controlled independently.

In an embodiment, the pixel arrangement further comprises a switchable electrical interconnection between the output of the first amplifier and the output of the second amplifier, the electrical interconnection being electrically arranged in parallel with the sample-and-hold stage.

That the electrical interconnection is switchable can mean that it comprises a switch. In an embodiment, the switchable electrical interconnection comprises a precharge switch that is electrically coupled to the output of the first amplifier and to the output of the second amplifier, such that the electrical interconnection is switchable. In particular, the precharge switch may be implemented as precharge transistor. A first terminal of the precharge transistor is electrically connected to the output of the first amplifier, in particular to the source terminal of the first source follower. A second terminal of the precharge transistor is electrically connected to the output of the second amplifier, in particular to the source terminal of the second source follower. A gate terminal of the precharge transistor is configured to receive a precharge signal. By closing the precharge switch, i.e. by applying the precharge signal, the electrical interconnection becomes conductive. Thus, the first amplifier, i.e. the first source follower, can be biased, wherein the column bus may provide a virtual ground potential. Further, by closing the precharge switch the electrical interconnection can be used as signal path to the column bus. In particular, the S/H stage and the second source follower can be bypassed. It is possible that at least one further switch is arranged between the precharge switch and the output of the first amplifier. In an example, the first switch that is assigned to the first capacitor is arranged in between.

In an embodiment, the pixel arrangement comprises a conversion stage configured to convert electromagnetic radiation into electrical signals, a sample-and-hold stage configured to store electrical signals from the conversion stage, a readout stage configured to read electrical signals stored in the sample-and-hold stage, a first amplifier electrically connected at its input to the conversion stage and at its output to the sample-and-hold stage, a second amplifier electrically connected at its input to the sample-and-hold stage and at its output to the readout stage, wherein the second amplifier is switchably electrically coupled to a supply terminal. The pixel arrangement further comprises a switchable electrical interconnection between the output of the first source follower and the output of the second source follower, the electrical interconnection being electrically arranged in parallel with the sample-and-hold stage.

The described pixel arrangement may form a voltage domain global shutter pixel with an S/H stage to temporarily store the global shutter signal for subsequent readout. However, it may be desired to operate such pixel arrangement in a rolling shutter mode as well. For that purpose, the described pixel arrangement is different from conventional pixel arrangements in that it comprises a switchable electrical interconnection between the output of the first amplifier and the output of the second amplifier, the electrical interconnection being electrically arranged in parallel with the sample-and-hold stage. Thus, it is not required to electrically couple the readout stage to the storage capacitors, which would make the readout slow since the capacitances of the capacitors are limiting the bandwidth. Rather, the rolling shutter signal is read via the electrical interconnection bypassing the S/H stage. Thus, the readout stage may be configured to read electrical signals from the conversion stage. Thus, joining of the global and rolling shutter signal path is different. As a consequence in the proposed pixel arrangement, the readout of rolling shutter signals is fast. Further, during readout, a rolling shutter signal does not go through two source follower stages as in conventional pixel arrangements, which would increase the noise. Rather, by bypassing the second amplifier it only goes through one source follower stage. As a consequence in the proposed pixel arrangement, the noise is reduced. A further advantage is that the rolling shutter readout does not affect the stored global shutter samples in the S/H stage. Thus, the rolling shutter readout is a non-destructive readout and therefore it will allow creative combinations of rolling shutter and global shutter readout. Thus, the pixel arrangement allows a non-destructive readout of rolling shutter samples in a voltage domain global shutter pixel. Further, the electrical interconnection is not directly connected to the column bus, but only via the select switch. If it was directly coupled to the column bus, this would increase the capacitance of the column bus significantly since an extra transistor per pixel (precharge switch) would be connected to it. The proposed pixel arrangement avoids such increased capacitance by coupling the electrical interconnection to the column bus via the select switch. Therefore, the readout is faster. This comes at the expense of an extra transistor (supply switch) to cut the supply of the second amplifier during global shutter sampling and rolling shutter readout. If the second amplifier was not disconnected from supply, it would fight against the voltage on the node between the second amplifier and the select switch, depending on what is stored on the in-pixel sample capacitors. However, the supply switch may be provided globally or per column or per row, which means that it may be common to at least a group of pixels. It is also possible that each pixel arrangement comprises a supply switch.

Furthermore, an imaging device is provided that comprises the pixel arrangement. This means that all features disclosed for the pixel arrangement are also disclosed for and applicable to the imaging device and vice-versa.

The imaging device may be implemented by CMOS technology. In particular, the imaging device may form a CMOS image sensor. The imaging device can be conveniently employed in optoelectronic devices, such as smart phones, tablet computers, laptops, or camera modules. Other applications include augmented reality (AR) and/or virtual reality (VR) scenarios. Further, the image sensor can be implemented in drones or scanning systems, as well as in industrial applications like machine vision. Further, the image sensor is in particular suited to be operated in global shutter mode, as the signals can be stored in a pixel level memory. The global shutter mode is in particular suited for infrared applications, where the optoelectronic device further comprises a light source that is synchronized with the pixels. Thus, an imaging device may also work in the infrared (IR) domain, for example for 3D imaging and/or identification purposes. However, some applications may benefit from the fast and low noise readout mode, which does not necessarily need the global shutter function. Reading out in rolling shutter mode significantly reduces the pixel noise.

Furthermore, a method for operating a pixel arrangement is provided. The pixel arrangement described above can preferably be employed for the method for operating the pixel arrangement described herein. This means that all features disclosed for the pixel arrangement are also disclosed for the method for operating the pixel arrangement and vice-versa.

In an embodiment, the method comprises generating, in a conversion phase at a conversion stage, an electrical signal by conversion of electromagnetic radiation, the electrical signal being one of a global shutter signal and a rolling shutter signal.

The method further comprises storing, in a global shutter sampling phase at a sample-and-hold stage, the global shutter signal from the conversion stage, wherein the conversion stage and the sample-and-hold stage are electrically coupled via a first amplifier that is electrically connected at its input to the conversion stage and at its output to the sample-and-hold stage.

The method further comprises reading, in a global shutter readout phase at a readout stage, the global shutter signal stored at the sample-and-hold stage, wherein the sample-and-hold stage and the readout stage are electrically coupled via a second amplifier that is electrically connected at its input to the sample-and-hold stage and at its output to the readout stage, wherein the second amplifier is switchably electrically coupled to a supply terminal.

The method further comprises reading, in a rolling shutter readout phase at the readout stage, the rolling shutter signal from the conversion stage via a switchable electrical interconnection between the output of the first amplifier and the output of the second amplifier, the switchable electrical interconnection being electrically arranged in parallel with the sample-and-hold stage.

Whether the electrical signal generated at the conversion stage is a rolling shutter or global shutter signal may depend on the respective mode of operation that is currently used for the pixel arrangement. Whether the electrical signal generated at the conversion stage is a rolling shutter or global shutter signal may also depend on the illumination and/or the image to be captured and/or on a user input and/or on a computer program and/or on a predefined sequence of operational modes. The rolling shutter signal and the global shutter signal may be equal or it may be different. For example, the rolling shutter signal and the global shutter signal are generated by using different exposure/integration times.

In an embodiment, the conversion stage generates the rolling shutter signal and the global shutter signal in different conversion phases during operation. This can mean that the conversion phase of generating the rolling shutter signal relates to a different time frame than the conversion phase of generating the global shutter signal. For example, the rolling shutter signal is generated in a later or subsequent conversion phase after the conversion phase of generating the global shutter signal, or vice-versa. For example, the method comprises in a first conversion phase generating a global shutter signal. For example, the method comprises in a second conversion phase generating a rolling shutter signal. For example, the second conversion phase is later than the first conversion phase, or vice-versa. Correspondingly, the rolling shutter readout phase and the global shutter readout phase may relate to different time frames during pixel operation.

In an embodiment, the pixel arrangement is selectively operated in global shutter mode and in rolling shutter mode. This can mean that the mode of operation is changed during operating the pixel arrangement. As mentioned above, in rolling shutter mode the pixels of a pixel matrix are sequentially exposed. In global shutter mode all pixels of a pixel matrix are exposed during the same time period. As mentioned above, the mode of operation of the pixel arrangement may be controlled by the illumination level and/or the image to be captured and/or on a user input and/or on a computer program and/or on a predefined sequence of operational modes.

Advantageously, the pixel arrangement is suited for both global shutter and rolling shutter mode. Thus, the method advantageously utilizes both operating modes. Further, the pixel arrangement allows a hybrid global and rolling shutter readout. The method makes use of a VGS pixel with an S/H stage to temporarily store the global shutter signal for subsequent readout. During sampling phase of the global shutter signal, the electrical interconnection is used to provide a virtual ground potential. During readout of the rolling shutter signal the electrical interconnection can be used as readout path, thereby improving speed and noise characteristics of the rolling shutter readout by bypassing the S/H stage and the second amplifier. Further, the rolling shutter readout does not affect the stored global shutter samples in the S/H stage. Thus, the rolling shutter readout is a non-destructive readout and therefore it will allow creative combinations of rolling shutter and global shutter readout. Further, the capacitance of the column bus is not increased.

In an embodiment, the method further comprises storing, in the global shutter sampling phase at the sample-and-hold stage, a reset level from the conversion stage. In an embodiment, the method further comprises reading, in the global shutter reading phase at the readout stage, the reset level stored at the sample-and-hold stage. In an embodiment, the method further comprises reading, in the rolling shutter reading phase at the readout stage, the reset level from the conversion stage via the switchable electrical interconnection.

In an embodiment, in the global shutter sampling phase the second amplifier is electrically disconnected from the supply terminal. This can mean that a supply switch that is electrically connected between the second amplifier and the supply terminal is in an open state (deactivated). Thus, a node between the output of the second amplifier and the input of the readout stage (in particular a select gate of the readout stage) is not biased by the second amplifier.

Advantageously, the second amplifier does not fight against a voltage on said node.

In an embodiment, in the global shutter sampling phase the switchable electrical interconnection electrically connects a column bus of the pixel arrangement to the first amplifier, such that the column bus provides a virtual ground potential. This can mean that a precharge switch that is comprised by the electrical interconnection is closed (activated). Thus, the electrical interconnection is conductive and shorts the output of the first amplifier to the output of the second amplifier (i.e. the input of the readout stage). Advantageously, a column bus comprised by the readout stage may provide a virtual ground potential. Therefore, the electrical signal can be transferred to and sampled/stored in the S/H stage. Advantageously, the capacitance of the column bus is not increased.

In an embodiment, in the global shutter readout phase the second amplifier is electrically connected to the supply terminal. This can mean that the supply switch that is electrically connected between the second amplifier and the supply terminal is in a closed state (activated). Thus, the column bus can be actively driven.

In an embodiment, in the global shutter readout phase the switchable electrical interconnection is electrically interrupted. This can mean that the precharge switch that is comprised by the electrical interconnection is open (deactivated). Thus, the electrical interconnection is interrupted and the output of the first amplifier is electrically disconnect from the output of the second amplifier (i.e. the input of the readout stage).

In an embodiment, in the rolling shutter readout phase the second amplifier is electrically disconnected from the supply terminal. This can mean that a supply switch that is electrically connected between the second amplifier and the supply terminal is in an open state (deactivated). Thus, a node between the output of the second amplifier and the input of the readout stage (in particular the select gate of the readout stage) is not biased by the second amplifier. Advantageously, the second amplifier does not fight against a voltage on said node.

In an embodiment, in the rolling shutter readout phase the switchable electrical interconnection provides a readout path to a column bus of the pixel arrangement. This can mean that the precharge switch that is comprised by the electrical interconnection is closed (activated). Thus, the electrical interconnection is conductive and shorts the output of the first amplifier to the output of the second amplifier (i.e. the input of the readout stage). Advantageously, a readout path for the rolling shutter signal is provided.

In an embodiment, in the global shutter sampling phase the precharge switch of the switchable electrical interconnection and/or the select switch of the readout stage are driven by a bias signal. This can mean that a bias voltage is applied to the precharge switch and/or the selection switch. At least one of the precharge signal and the select signals can be chosen to be driven by a bias signal to limit the peak current while the sampling is active. Thus, at least one of the precharge switch and the select switch serves as current source for the first amplifier.

Further embodiments of the method become apparent to the skilled reader from the embodiments of the pixel arrangement described above, and vice-versa.

### BRIEF DESCRIPTION OF THE DRAWINGS

The following description of figures may further illustrate and explain aspects of the pixel arrangement and the method of operating such pixel arrangement. Components and parts of the pixel arrangement that are functionally identical or have an identical effect are denoted by identical reference symbols. Identical or effectively identical components and parts might be described only with respect to the figures where they occur first. Their description is not necessarily repeated in successive figures.

FIG. 1 shows an embodiment of a pixel arrangement.

FIG. 2 shows a signal timing diagram of the embodiment according to FIG. 1.

FIG. 3 shows another signal timing diagram of the embodiment according to FIG. 1.

FIG. 4 shows another signal timing diagram of the embodiment according to FIG. 1.

FIG. 5 shows another embodiment of a pixel arrangement.

FIG. 6 shows another embodiment of a pixel arrangement.

FIG. 7 shows another embodiment of a pixel arrangement.

FIG. 8 shows a schematic of an imaging device comprising a pixel arrangement.

### DETAILED DESCRIPTION

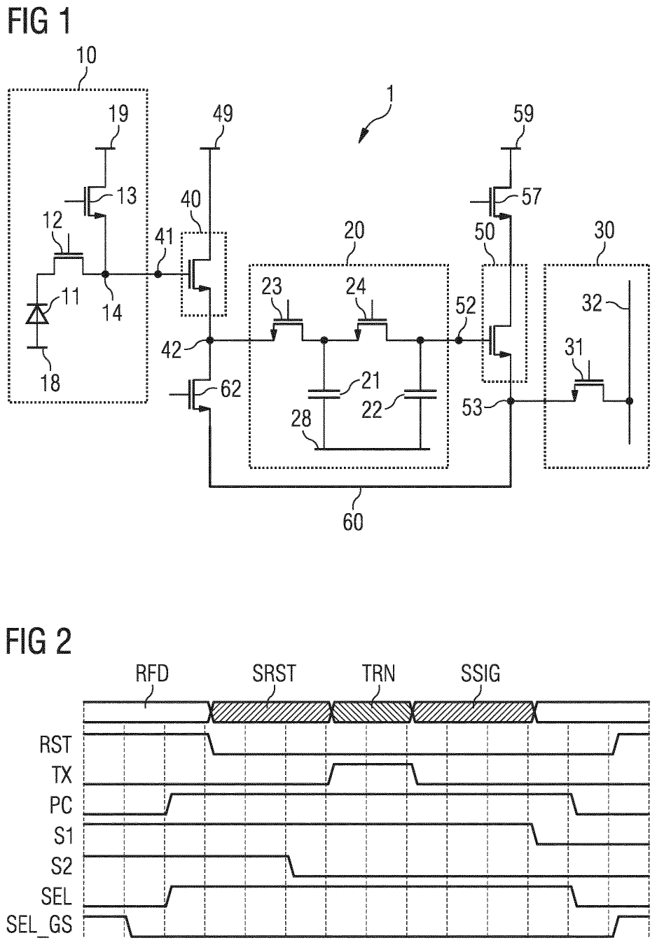

In FIG. 1 an embodiment of a pixel arrangement 1 is shown. The pixel arrangement 1 according to FIG. 1 comprises a conversion stage 10 that is configured to convert electromagnetic radiation into electrical signals. The pixel arrangement further comprises a sample-and-hold stage 20 (S/H stage 20) configured to store electrical signals from the conversion stage 10. It further comprises a readout stage 30 configured to read electrical signals stored in the sample-and-hold stage 20. A first amplifier 40 is electrically connected at its input 41 to the conversion stage 10 and at its output 42 to the sample-and-hold stage 20. A second amplifier 50 is electrically connected at its input 52 to the sample-and-hold stage 20 and at its output 53 to the readout stage 30. The second amplifier 50 is switchably electrically coupled to a supply terminal 59. The pixel arrangement further comprises a switchable electrical interconnection 60 between the output 42 of the first amplifier 40 and the output 53 of the second amplifier 50. The electrical interconnection 60 is electrically arranged in parallel with the sample-and-hold stage 20.

The input 41 of the first amplifier 40 simultaneously forms an output of the conversion stage 10. The output 42 of the first amplifier 40 simultaneously forms an input of the sample-and-hold stage 20. The input 52 of the second amplifier 50 simultaneously forms an output of the S/H stage 20. The output 53 of the second amplifier 50 simultaneously forms an input of the readout stage 30. In other words, the S/H stage 20 is electrically coupled to the conversion stage 10 via the first amplifier 40. The readout stage 30 is electrically coupled to the S/H stage 20 via the second amplifier 50. The electrical interconnection 60 bypasses the S/H stage 20 and the second amplifier 50. The electrical interconnection 60 is directly connected to the input of the readout stage 30, i.e. the output 53 of the second amplifier. The electrical interconnection 60 may be directly connected to the output 42 of the first amplifier, i.e. the input of the S/H stage 20. However, it is also possible that further components like switches are arranged in between.

In the embodiment shown in FIG. 1 the conversion stage comprises a photodetector 11. The conversion stage 10 further comprises a transfer switch 12. The conversion stage 10 further comprises a reset switch 13. The conversion stage 10 further comprises a circuit node 14. The circuit node 14 forms the output of the conversion stage 10. The transfer switch 12 is electrically connected between the photodetector 11 and the circuit node 14. The reset switch 13 is electrically connected between the circuit node 14 and a further supply terminal 19.

The photodetector 11 is implemented as photodiode. The photodiode comprises an anode terminal and cathode terminal, wherein the anode terminal is electrically connected to a ground (GND) terminal 18 or a negative pixel supply (VSS) terminal 18. In the example of FIG. 1 the transfer switch 12 is implemented as transfer transistor, wherein one terminal of the transistor is electrically connected to the cathode terminal of the photodiode, and the other one terminal is electrically connected to the circuit node 14. A gate terminal of the transfer transistor is configured to receive a transfer signal TX, as shown in FIGS. 2 to 4. In the example of FIG. 1 the reset switch 13 is implemented as reset transistor, wherein one terminal of the transistor is electrically connected to the circuit node 14, and the other one terminal is electrically connected to the further supply terminal 19. The further supply terminal 19 may provide the same potential as the supply terminal 59, e.g. a positive pixel supply voltage (VDD). However, the further supply terminal 19 may also provide a potential different from the supply terminal 59. A gate terminal of the reset transistor is configured to receive a reset signal RST, as shown in FIGS. 2 to 4.

In the embodiment shown in FIG. 1 the first amplifier 40 is implemented as first source follower, also known as common-drain amplifier. A gate terminal forms the input 41 of the first source follower and is electrically connected to the circuit node 14. A source terminal forms the output 42 of the first source follower and is electrically connected to an input node of the S/H stage 20. A drain terminal of the first source follower is electrically connected to a further supply terminal 49, which may also provide VDD.

In the embodiment shown in FIG. 1 the sample-and-hold stage 20 comprises a first capacitor 21 configured to store a voltage signal, which may be a video signal generated at the conversion stage 10. The sample-and-hold stage 20 further comprises a second capacitor 22 configured to store a further voltage signal, which may be a reset level generated at the conversion stage 10. The first capacitor 21 and the second capacitor 22 are implemented as in-pixel storage capacitors. The first capacitor 21 and the second capacitor 22 are implemented as switchable capacitors. This can mean that respective switches are assigned to the capacitors 21, 22.

Thus, the S/H stage 20 further comprises a first switch 23 and a second switch 24. In the shown example, the first and the second switch are implemented as transistors. A first terminal of the first switch 23 is electrically connected to the input node of the S/H stage, i.e. the output 42 of the first amplifier 40. A second terminal of the first switch 23 is electrically connected to a node of the first capacitor 21. A gate terminal of the first switch is configured to receive a first switch signal S1, as shown in FIGS. 2 to 4. A first terminal of the second switch 24 is electrically connected to the node of the first capacitor 21. A second terminal of the second switch 24 is electrically connected to a node of the second capacitor 22. This node forms the output of the S/H stage 20 and the input 52 of the second amplifier 50, respectively. A gate terminal of the second switch is configured to receive a second switch signal S2, as shown in FIGS. 2 to 4. The respective other nodes of the storage capacitors 21, 22 are electrically connected to a reference terminal 28, which may provide a reference potential Vref. It is also possible (but not shown) that the two storage capacitors 21, 22 are connected to different reference potentials. In the shown example of FIG. 1 the first capacitor 21 and the second capacitor 22 are electrically arranged cascaded. This means that the second capacitor cannot be controlled independently from the first capacitor 21.

In the embodiment shown in FIG. 1 the second amplifier 50 is implemented as second source follower. A gate terminal forms the input 52 of the second source follower and is electrically connected to the output of the S/H stage 20, which may be the node of the second capacitor 22 in this case. A source terminal forms the output 53 of the second source follower and is electrically connected to an input node of the readout stage 30. A drain terminal of the second source follower is switchably electrically connected to the supply terminal 59. That the drain terminal is switchably connected to the supply terminal 59 can mean that a switch is arranged in between, as shown in FIG. 1. In particular, the pixel arrangement 1 comprises a supply switch 57 that is electrically connected between the second amplifier 50 and the supply terminal 59, such that the second amplifier 50 is switchably electrically coupled to the supply terminal 59. The supply switch 57 is implemented as transistor, wherein one terminal is connected to the drain terminal of the second source follower, and the other terminal is connected to the supply terminal 59. A gate terminal of the supply switch 57 is configured to receive a control signal SEL_GS, as shown in FIGS. 2 to 4.

In the embodiment according to FIG. 1 the readout stage 30 comprises a select switch 31 and at least a portion of a column bus 32, wherein the select switch 31 is electrically connected between the column bus 32 and an input of the readout stage 30. The column bus 32 connects a group of pixels, in particular pixels of the same column within a pixel array. Further, the column bus 32 connects the pixels to a readout circuit (not shown). The readout circuit is not part of the pixel arrangement 1. The select switch 31 can be implemented as transistor, as shown in FIG. 1. One terminal of the select switch 31 is connected to the output 53 of the second amplifier 50, and the other terminal is connected to the column bus 32. A gate terminal of the select switch 31 is configured to receive a select signal SEL, as shown in FIGS. 2 to 4.

That the electrical interconnection 60 is switchable means that it may comprise a precharge switch 62, as shown in FIG. 1. The precharge switch 62 is electrically coupled to the output 42 of the first amplifier 40 and to the output 53 of the second amplifier 50, such that the electrical interconnection 60 is switchable. The precharge switch 62 may be implemented as transistor. A gate terminal of the transistor is configured to receive a precharge signal PC, as shown in FIGS. 2 to 4.

The shown pixel arrangement 1 is suited for both global shutter and rolling shutter mode.

FIG. 2 shows a possible signal timing during a global shutter sampling phase at a specific time frame. It should be noted that the signal timing shown is more of an example and could be varied. Furthermore, the scaling of the time intervals should not be taken as an exact indication. As the pixel arrangement 1 can be a VGS pixel, exposure and frame storage can be global operations, i.e. exposure and frame storage can affect each pixel arrangement 1 of an array of pixels simultaneously.

FIG. 2 shows the timing of the reset signal RST, the transfer signal TX, the precharge signal PC, the first switch signal S1, the second switch signal S2, the select signal SEL and the control signal SEL_GS. These signals can be in an activated state (high state) or in a deactivated state (low state). Applying or activating the respective signal can mean that the signal is switched to the activated state. Deactivating the respective signal can mean that the signal is switched to the deactivated state. In the following, the timing is explained in more detail using selected phases shown in the figure.

In a first phase RFD (“Reset Floating Diffusion”) of the global shutter sampling phase the circuit node 14 is reset. In that phase the reset signal RST is activated resulting in redundant charge carriers being removed from the circuit node 14.

In a second phase SRST (“Sampling Reset”) of the global shutter sampling phase the reset level of the pixel arrangement 1 is transferred to the second capacitor 22. Therefore, the reset signal RST is deactivated. The precharge signal PC and the select signal SEL are activated to bias the first amplifier 40. By activating these signals the first amplifier 40 is electrically connected to a virtual ground potential provided by the column bus 32. Further, the control signal SEL_GS is deactivated, such that the second amplifier 50 does not fight against the voltage on the output 53 of the second amplifier 50, depending on what is stored on the in-pixel sample capacitors 21, 22. Further, the first switch signal S1 and the second switch signal S2 are activated to electrically connect the second capacitor 22 to the output 42 of the first amplifier 40. The reset level is stored on the second capacitor 22 by deactivating the second switch signal S2 in the course of this phase. It should be noted that the reset level is distributed between the first capacitor 21 and the second capacitor 22, since also the first capacitor 21 is connected to the output 42 of the first amplifier 40.

In a third phase TRN (“Transfer”) of the global shutter sampling phase the video signal of the pixel arrangement 1 is transferred to the circuit node 14 and to the first capacitor 21. For that, the transfer signal TX is applied. Accumulated charge carrier at the photodetector 11 can diffuse to the circuit node 14 and thus to the input 41 of the first amplifier 40. The first capacitor 21 is still connected to the output 42 of the first amplifier 40 by an activated first switch signal S1. At the end of the third phase TRN the transfer signal TX is deactivated.

In a fourth phase SSIG (“Sampling Signal”) of the global shutter sampling phase the video signal is sampled and stored on the first capacitor 21. This is achieved by deactivating the first switch signal S1, such that the first capacitor 21 is electrically decoupled. The video signal stored on the first capacitor 21 can be a correlated double sampled signal (CDS) by respecting the reset level.

It is noted that in the global shutter sampling phase the precharge signal PC and/or the select signal SEL can be chosen to be driven by a bias signal to limit the peak current while the sampling is active. Thus, at least one of the respective switches may serve as current source for the first amplifier 40.

The phase after the fourth phase SSIG (not labeled) may correspond to the next time frame.

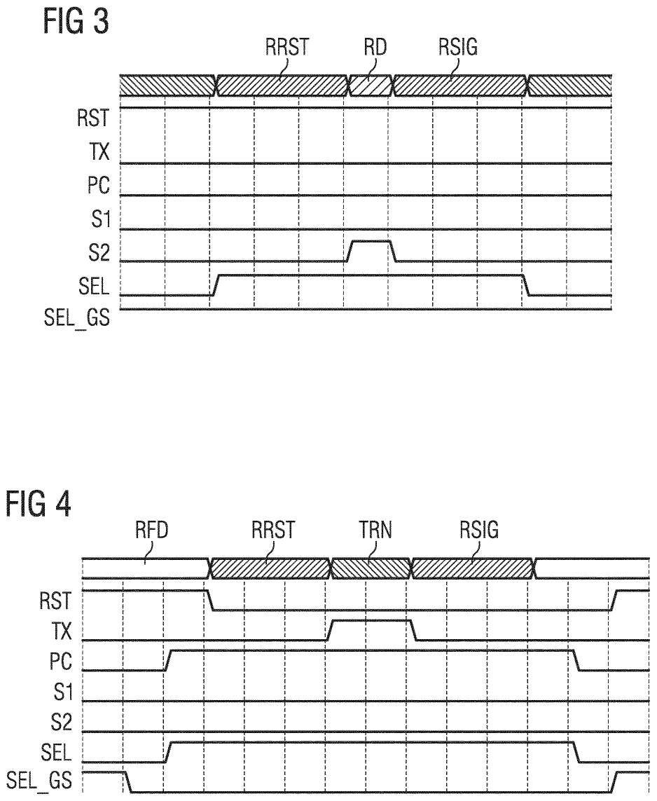

FIG. 3 shows a possible signal timing during a global shutter readout phase at a specific time frame. Again, the signal timing shown is more of an example and could be varied. The scaling of the time intervals should not be taken as an exact indication. Reading out the signals stored in the S/H stage may be conducted subsequently for each row of an array of pixel arrangements 1.

Again, the timing of the reset signal RST, the transfer signal TX, the precharge signal PC, the first switch signal S1, the second switch signal S2, the select signal SEL and the control signal SEL_GS is shown.

In a first phase RRST (“Read Reset”) the reset level is read out. This is achieved by activating the control signal SEL_GS, such that the column bus 32 is actively driven. Further, the select signal SEL is activated to electrically connect the column bus 32 to the output 53 of the second amplifier 50. As such, the reset level can be transferred via the column bus 32 to a readout circuit.

In a second phase RD (“Redistribution”) the video signal is redistributed on the first and the second capacitor 21, 22 by activating and deactivating the second switch signal S2.

In a third phase RSIG (“Read Signal”) the video signal is read by transferring it via the column bus 32 to the readout circuit. The select signal SEL and the control signal SEL_GS are still activated. At the end of reading the select signal SEL is deactivated.

The phase before the first phase rrst and the phase after the third phase RSIG as shown in FIG. 3 may correspond to readout phases of previous and subsequent rows, respectively.

FIG. 4 shows a possible signal timing during a rolling shutter readout phase. Again, the signal timing shown is more of an example and could be varied. The scaling of the time intervals should not be taken as an exact indication. Reading out the signals in rolling shutter mode may be conducted subsequently for each row of an array of pixel arrangements 1.

Again, the timing of the reset signal RST, the transfer signal TX, the precharge signal PC, the first switch signal S1, the second switch signal S2, the select signal SEL and the control signal SEL_GS is shown.

In a first phase RFD (“Reset Floating Diffusion”) of the rolling shutter readout phase the circuit node 14 is reset. In that phase the reset signal RST is activated resulting in redundant charge carriers being removed from the circuit node 14.

In a second phase RRST (“Read Reset”) of the rolling shutter readout phase the reset level of the pixel arrangement 1 is transferred to the column bus 32 via the electrical interconnection 60. Therefore, the reset signal RST is deactivated. The precharge signal PC and the select signal SEL are activated to bias the first amplifier 40 and to provide a readout path. Further, the control signal SEL_GS is deactivated, such that the second amplifier 50 does not fight against the voltage on the output 53 of the second amplifier 50, depending on what is stored on the in-pixel sample capacitors 21, 22. Further, the first switch signal S1 and the second switch signal S2 are deactivated, such that the in-pixel sample capacitors 21, 22 are bypassed. The reset level is therefore transferred to the readout circuit via the electrical interconnection 60, the readout stage 30 and the column bus 32.

In a third phase TRN (“Transfer”) of the rolling shutter readout phase the video signal of the pixel arrangement 1 is transferred to the circuit node 14. For that, the transfer signal TX is applied, such that accumulated charge carriers at the photodetector 11 can diffuse to the circuit node 14 and therefore to the input 41 of the first amplifier 40.

In a fourth phase RSIG (“Read Signal”) of the rolling shutter readout phase the video signal is read. The first and the second switch signals S1 and S2 are still deactivated, such that the S/H stage is electrically decoupled. The precharge signal PC and the select signal SEL are activated, such that a readout path to the column bus 32 is provided. Further, the control signal SEL_GS is deactivated, such that the second amplifier 50 does not fight against the voltage on the output 53 of the second amplifier 50, depending on what is stored on the in-pixel sample capacitors 21, 22.

The subsequent phase (not labeled) may correspond to an end of read procedure and to a next time frame.

FIG. 5 shows another embodiment of the pixel arrangement 1. The embodiment according to FIG. 5 is different from the embodiment of FIG. 1 in that the electrical interconnection 60 with the precharge switch 62 is arranged differently. In particular, the first switch 23 is arranged between the output 42 of the first amplifier 40 and the precharge switch 62. In other words, the precharge switch 62 connects a node of the first capacitor 21 to the output 53 of the second amplifier 50. In that embodiment, the first switch 23 may be regarded as part of the electrical interconnection 60, instead of being part of the S/H stage 20 as in the embodiment of FIG. 1. However, the first switch 23 still aims to electrically connect the output 42 of the first amplifier 40 to the first capacitor 21, such that the first capacitor 21 is switchable. Further, the electrical interconnection still bypasses the capacitors 21, 22 of the S/H stage, such that an alternative readout path is provided for a rolling shutter signal.

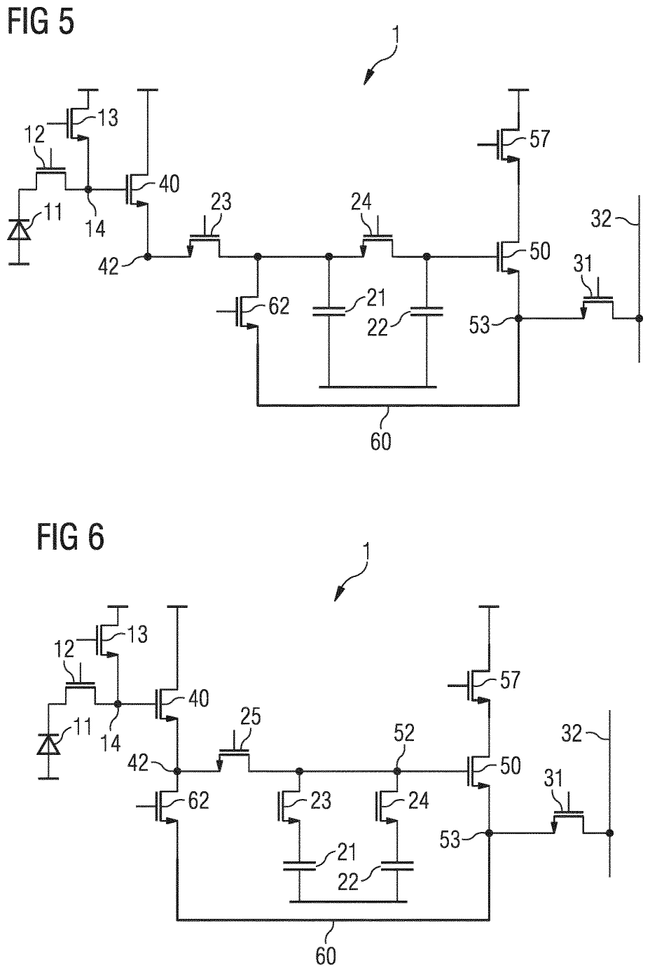

FIG. 6 shows another embodiment of the pixel arrangement 1. The embodiment according to FIG. 6 is different from the embodiment of FIG. 1 in that the first capacitor 21 and the second capacitor 22 are electrically arranged in parallel. This means that they can be controlled independently via the first switch 23 and the second switch 24. One terminal of the first switch 23 is electrically connected to a node of the first capacitor 21 and the other terminal is electrically connected to the input of the second amplifier 50, i.e. the output of the S/H stage 20. Correspondingly, one terminal of the second switch 24 is electrically connected to a node of the second capacitor 22 and the other terminal is electrically connected to the input 52 of the second amplifier 50. A further switch 25 is electrically connected between the output 42 of the first amplifier 40 and the input 52 of the second amplifier 50. The further switch 25 can also be implemented as transistor, as shown in FIG. 6. A gate terminal of the further switch 25 is configured to receive a further switch signal in order to electrically connect the S/H stage 20 to the output 42 of the first amplifier 40, such that a global shutter signal can be sampled. However, if the further switch 25 is open (deactivated), a rolling shutter signal can be bypassed via the electrical interconnection 60. Therefore, the embodiment according to FIG. 6 requires an extra transistor (further switch 25). For this, the capacitors 21, 22 can be controlled independently of each other.

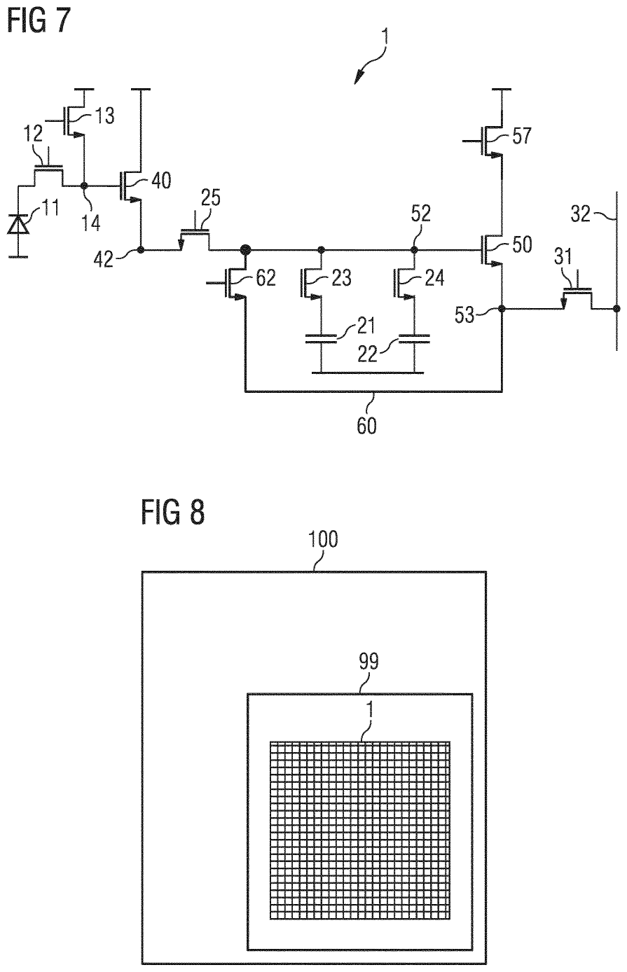

FIG. 7 shows another embodiment of the pixel arrangement 1. The embodiment according to FIG. 7 is different from the embodiment of FIG. 6 in that the electrical interconnection 60 with the precharge switch 62 is arranged differently and as in the embodiment of FIG. 5. In particular, the further switch 25 is arranged between the output 42 of the first amplifier 40 and the precharge switch 62. In that embodiment, the further switch 25 may be regarded as part of the electrical interconnection 60, instead of being part of the S/H stage 20 as in the embodiment of FIG. 6.

The signal timing for the embodiments according to FIGS. 5 to 7 may differ from the signal timing shown in FIGS. 2 to 4. However, a skilled person will easily determine the necessary modifications in the signal timing, since the circuit principle is essentially identical. For the sake of clarity, the signal timing is therefore not shown again.

In FIG. 8 an imaging device 100 comprising the pixel arrangement 1 is shown schematically. The pixel arrangement 1 can be comprised by a two-dimensional matrix comprising a plurality of pixel arrangements 1, as indicated in FIG. 8. The imaging device 100 may comprise further components 99, for example other circuit elements or a light source that is synchronized with the pixel arrangement 1 or the plurality of pixel arrangements 1.

The embodiments of the pixel arrangement 1 and the method of operating such pixel arrangement 1 disclosed herein have been discussed for the purpose of familiarizing the reader with novel aspects of the idea. Although preferred embodiments have been shown and described, many changes, modifications, equivalents and substitutions of the disclosed concepts may be made by one having skill in the art without unnecessarily departing from the scope of the claims.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art and fall within the scope of the appended claims.

The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

This patent application claims the priority of German patent application 102023106613.7, the disclosure content of which is hereby incorporated by reference.

### REFERENCES

1 pixel arrangement
10 conversion stage
11 photodetector
12 transfer switch
13 reset switch
14 circuit node
18 ground terminal
19 supply terminal
20 sample-and-hold stage
21 first capacitor
22 second capacitor
23 first switch
24 second switch
25 further switch
28 reference terminal
30 readout stage
31 select switch
32 column bus
40 first amplifier
41 input of first amplifier
42 output of first amplifier
49 supply terminal
50 second amplifier
52 input of second amplifier
53 output of second amplifier
57 supply switch
59 supply terminal
60 electrical interconnection
62 precharge switch
99 component
100 imaging device
PC precharge signal
RD redistribution phase
RFD reset floating diffusion phase
RRST read reset phase
RSIG read signal phase
RST reset signal
S1 first switch signal
S2 second switch signal
SEL select signal
SEL_GS control signal
SRST sampling reset phase
SSIG sampling signal phase
TRN transfer phase
TX transfer signal

1. Pixel arrangement, comprising:
a conversion stage configured to convert electromagnetic radiation into electrical signals,
a sample-and-hold stage configured to store electrical signals from the conversion stage,
a readout stage configured to read electrical signals stored in the sample-and-hold stage,
a first amplifier electrically connected at its input to the conversion and at its output to the sample-and-hold stage,
a second amplifier electrically connected at its input to the sample-and-hold stage and at its output to the readout stage,
wherein the second amplifier is switchably electrically coupled to a supply terminal, and
a switchable electrical interconnection between the output of the first amplifier and the output of the second amplifier, the electrical interconnection being electrically arranged in parallel with the sample-and-hold stage.

2. Pixel arrangement of claim 1, wherein the conversion stage comprises a photodetector, a transfer switch, a reset switch and a circuit node forming the output of the conversion stage, wherein the transfer switch is electrically connected between the photodetector and the circuit node, and wherein the reset switch is electrically connected between the circuit node and a further supply terminal.

3. Pixel arrangement according to claim 1, wherein the sample-and-hold stage comprises a first capacitor configured to store a voltage signal generated at the conversion stage.

4. Pixel arrangement according to claim 3, wherein the sample-and-hold stage further comprises a second capacitor configured to store a further voltage signal generated at the conversion stage.

5. Pixel arrangement according to claim 4, wherein the first capacitor and the second capacitor are electrically arranged cascaded or in parallel.

6. Pixel arrangement according to claim 1, wherein the readout stage comprises a select switch and at least a portion of a column bus, wherein the select switch is electrically connected between the column bus and an input of the readout stage.

7. Pixel arrangement according to claim 1, further comprising a supply switch that is electrically connected between the second amplifier and the supply terminal, such that the second amplifier is switchably electrically coupled to the supply terminal.

8. Pixel arrangement according to claim 1, wherein the switchable electrical interconnection comprises a precharge switch that is electrically coupled to the output of the first amplifier and to the output of the second amplifier, such that the electrical interconnection is switchable.

9. Imaging device comprising the pixel arrangement according to claim 1.

10. Method of operating a pixel arrangement, the method comprising:
generating, in a conversion phase at a conversion stage, an electrical signal by conversion of electromagnetic radiation, the electrical signal being one of a global shutter signal and a rolling shutter signal,
storing, in a global shutter sampling phase at a sample-and-hold stage, the global shutter signal from the conversion stage, wherein the conversion stage and the sample-and-hold stage are electrically coupled via a first amplifier that is electrically connected at its input to the conversion stage and at its output to the sample-and-hold stage,
reading, in a global shutter readout phase at a readout stage, the global shutter signal stored at the sample-and-hold stage, wherein the sample-and-hold stage and the readout stage are electrically coupled via a second amplifier that is electrically connected at its input to the sample-and-hold stage and at its output to the readout stage, wherein the second amplifier is switchably electrically coupled to a supply terminal,
reading, in a rolling shutter readout phase at the readout stage, the rolling shutter signal from the conversion stage via a switchable electrical interconnection between the output of the first amplifier and the output of the second amplifier, the switchable electrical interconnection being electrically arranged in parallel with the sample-and-hold stage.

11. Method according to claim 10, wherein the pixel arrangement is selectively operated in global shutter mode and in rolling shutter mode.

12. Method according to claim 10, wherein in the global shutter sampling phase the second amplifier is electrically disconnected from the supply terminal, and the switchable electrical interconnection electrically connects a column bus of the pixel arrangement to the first amplifier, such that the column bus provides a virtual ground potential.

13. Method according to claim 10, wherein in the global shutter readout phase the second amplifier is electrically connected to the supply terminal, and the switchable electrical interconnection is electrically interrupted.

14. Method according to claim 10, wherein in the rolling shutter readout phase the second amplifier is electrically disconnected from the supply terminal, and the switchable electrical interconnection provides a readout path to a column bus of the pixel arrangement.

15. Method according to claim 10, wherein in the global shutter sampling phase a precharge switch of the switchable electrical interconnection and/or a select switch of the readout stage are driven by a bias signal.

16. Pixel arrangement, comprising:
a conversion stage configured to convert electromagnetic radiation into electrical signals,
a sample-and-hold stage configured to store electrical signals from the conversion stage,
a readout stage configured to read electrical signals stored in the sample-and-hold stage,
a first amplifier electrically connected at its input to the conversion stage and at its output to the sample-and-hold stage,
a second amplifier electrically connected at its input to the sample-and-hold stage and at its output to the readout stage,
wherein the second amplifier is implemented as source follower whose drain terminal is switchably electrically coupled to a supply terminal, and
a switchable electrical interconnection between the output of the first amplifier and the output of the second amplifier, the electrical interconnection being electrically arranged in parallel with the sample-and-hold stage.
